(19) United States
(12) Patent Application Publication
(10) Pub. No.: US 2009/0083535 A1
(43) Pub. Date: Mar. 26, 2009

(54) INFORMATION PROCESSING APPARATUS

(75) Inventor: Toru Hanada, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/236,397

(22) Filed: Sep. 23, 2008

(30) Foreign Application Priority Data
Sep. 25, 2007 (JP) P2007-247838

(51) Int. Cl. G06F 9/00

(52) U.S. Cl. 713/2

(57) ABSTRACT

An information processing apparatus includes: a connection port to which an external device is connected; and a processor that executes a BIOS and runs an operating system, wherein, when executing the BIOS, the processor operates to: determine whether or not the external device is connected to the connection port; continues to perform a legacy process and boot the operating system when determined that a prescribed type of the external device is connected; and terminates the legacy process and boot the operating system when determined that the prescribed type of the external device is not connected.

### CROSS-REFERENCE TO RELATED APPLICATIONS

This application is based upon and claims the benefit of priority from Japanese Patent Application No. 2007-247838, filed on Sep. 25, 2007, the entire content of which are incorporated herein by reference.

### BACKGROUND

1. Field

One embodiment of the invention relates to an information processing apparatus having a connection port to which an external device can be detachably attached.

2. Description of the Related Art

An information processing apparatus disclosed in JP-A-2004-348453 includes a first pointing device shown on a display and a second pointing device for operating a pointer. When the first pointing device is usable, a first object is displayed on the display, and when the second pointing device is usable, a second object is displayed on the display.

In an operating system of a new type such as Windows VISTA®, when a personal computer is powered on under a state that a USB memory is inserted into a USB port of the personal computer, the personal computer reads and boots an operating system stored in the USB memory.

In order to boot the operating system stored in the USB memory, a system BIOS read from a BIOS-ROM when the personal computer is powered on needs to recognize the USB memory as a storage device from which the operating system can be read. Thus, to allow the system BIOS to recognize the USB device as a device of the same kind as a hard disk, a USB legacy process is performed.

An USB controller for controlling the USB device is To provided with a register. The resister has storing bits for storing: a BIOS control flag, which is set to “1” under a controlled state and set to “0” under a non-controlled state, indicating whether or not the system BIOS controls the USB controller and the USB device; and an OS control flag, which is set to “1” under a controlled state and set to “0” under a non-controlled state, indicating whether or not the operating system controls the USB controller and the USB device.

When booting the personal computer, since the system BIOS controls the USB controller and the USB device, the BIOS control flag is set to “1” and the OS control flag is set to “0”. When the operating system is read, the control of the USE controller and the USB device is taken over to the operating system from the system BIOS, the BIOS control flag is set to “0” and the OS control flag is set to “1”.

However, since the above-described process that the BIOS control flag is set to “0” and the OS control flag is set to “1” is performed only in the operating system of the new type such as the Windows VISTA®, in an operating system of an old type that has been previously used, a situation sometimes arises that the control of the USB device cannot be taken over to the operating system from the system BIOS so that the USB device cannot be normally used after the operating system is booted.

### SUMMARY

According to one aspect of the present invention, there is provided an information processing apparatus including: a connection port to which an external device is connected; and a processor that executes a BIOS and runs an operating system, wherein, when executing the BIOS, the processor operates to: determine whether or not the external device is connected to the connection port; continues to perform a legacy process and boot the operating system when determined that a prescribed type of the external device is connected; and terminates the legacy process and boot the operating system when determined that the prescribed type of the external device is not connected.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a perspective view of an information processing apparatus according to one embodiment of the present invention.

FIG. 2 is a block diagram of the information processing apparatus according to the embodiment.

FIG. 3 is a functional block diagram of a system BIOS used in the information processing apparatus according to the embodiment.

FIG. 4 is a flowchart indicating an activating process of the information processing apparatus according to the embodiment.

### DETAILED DESCRIPTION

Now, referring to the attached drawings, an embodiment of the present invention will be described in detail. In the following description, the same elements or elements having the same functions are designated by the same reference numerals and a duplicated explanation is omitted.

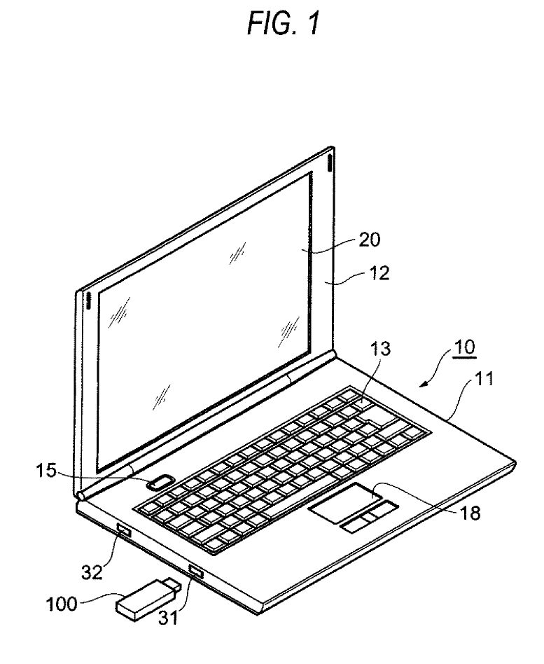

Referring to FIG. 1, an information processing apparatus 10 according to an embodiment of the present invention will be described.

The information processing apparatus 10 of the embodiment is a personal computer (notebook PC). The computer 10 includes a main unit 11 and a display unit 12. In the display unit 12, an LCD (Liquid Crystal Display) 20 is installed as a display device. A display screen of the LCD 20 is located substantially at a center of the display unit 12.

The main unit 11 has a thin box shaped casing and a keyboard 13, a power button switch 15 for turning on/off a power source of the computer 10, and a touch pad 18 are arranged on an upper surface of the casing. The display unit 12 is attached to the main unit 11 so as to pivot between an opened position where the display screen of the LCD 20 is exposed and a closed position where the display screen of the LCD 20 is closed.

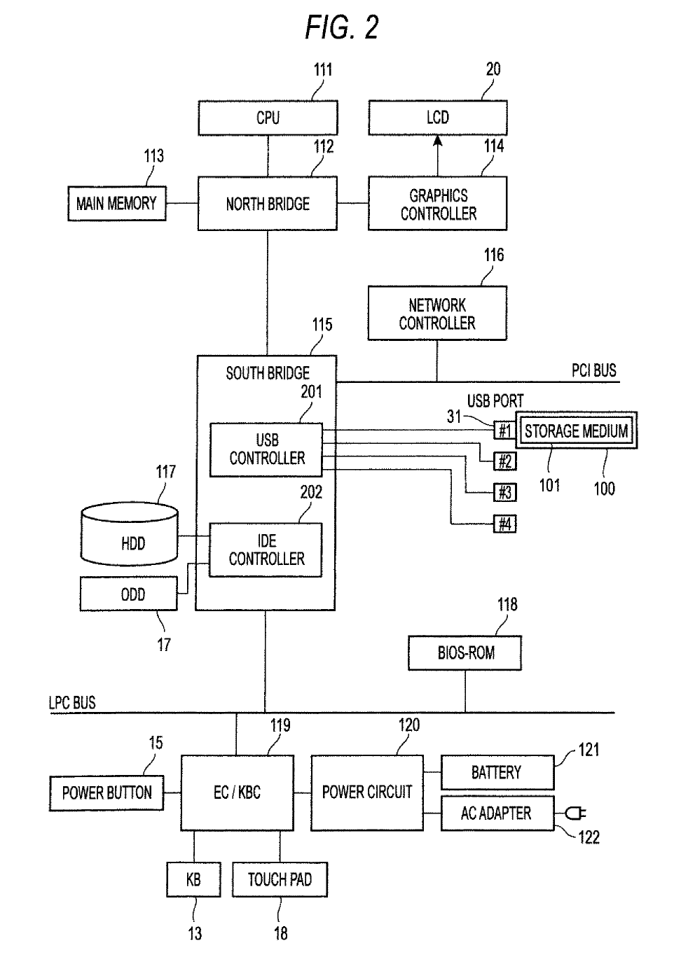

In a left side face of the computer 10, two connection ports 31 and 32 are arranged to which an external device 100 can be detachably attached. On a backface of the computer 10, two connection ports 33 and 34 (see FIG. 2) to which an external device can be detachably attached. The connection ports 31, 32, 33 and 34 are respectively based on the USB (Universal Serial Bus) standard and the external device 100 based on the USB standard can be attached thereto.

As the external device 100 that can be attached to the connection ports 31, 32, 33 and 34, exemplified are a USB keyboard having an interface of the USB standard, a USE mouse having an interface of the USB standard, a USB storage device such as a USB memory having an interface of the USB standard, etc. In the USB storage device, a storage medium 101 (see FIG. 2) including a non-volatile semiconductor memory such as a flash EEPROM is incorporated.

In the embodiment, the connection ports 31, 32, 33 and 34 and the external device 100 are based on the USB standard. However, the connection ports 31, 32, 33 and 34 and the external is device 100 may be based on other standard such as an IEEE 1394 standard.

Now, referring to FIG. 2, a system structure of the computer 10 will be described.

A CPU 111 is a processor for controlling respectively the operations of the components of the computer 10. The CPU 111 responds to turning on of a power of the computer 10 to load a system BIOS (Basic Input Output System) stored in a BIOS-ROM 118 in a main memory 113 and executes the system BIOS as a program for controlling a hardware. After that, the CPU 111 loads an operating system stored in an internal HDD 117 or the external storage device in the main memory 113 and runs the operating system.

A north bridge 112 is a bridge device for connecting the CPU 11 to a south bridge 115. The north bridge 112 is provided with a memory controller for controlling the main memory 113. Further, the north bridge 112 has a function for performing a communication with a graphics controller 114 through an ASP (Accelerated Graphics Port) bus. The graphics controller 114 is a display controller for controlling an LCD 20 as a display device of the computer 10.

The south bridge 115 is a bridge device for connecting the north bridge 112 to a peripheral device. The south bridge 115 is connected to a PCI device such as a network controller 116 through a PCI (Peripheral Computer Interconnect) bus. Further, the south bridge 115 is connected to, for example, the BIOS-ROM 118 or an embedded controller/keyboard controller IC (EC/KBC) 119 through an LPC (LowPin Count) bus.

Further, the south bridge 115 has a USB controller 201 and an IDE (Integrated Drive Electronics) controller 202. The USB controller 201 controls a USE device connected to the connection ports 31 to 34 or performs a communication. The IDE controller 202 controls the incorporated hard disk (HDD) 117 and an optical disk drive (ODD) 17.

The embedded controller/keyboard controller IC (EC/KBC) 119 is a one-chip microcomputer in which an embedded controller for controlling a power source and a keyboard controller for controlling the keyboard (KB) 13 and the touch pad 18 are integrated. The embedded controller/keyboard controller IC 119 cooperates with a power circuit 120 to turn on/off the power source of the computer 10 in accordance with the operation of the power button switch 15 by a user. The power circuit 120 generates a system power to be supplied to components respectively of the computer 10 by using an external power supplied through a battery 121 or an AC adapter 122.

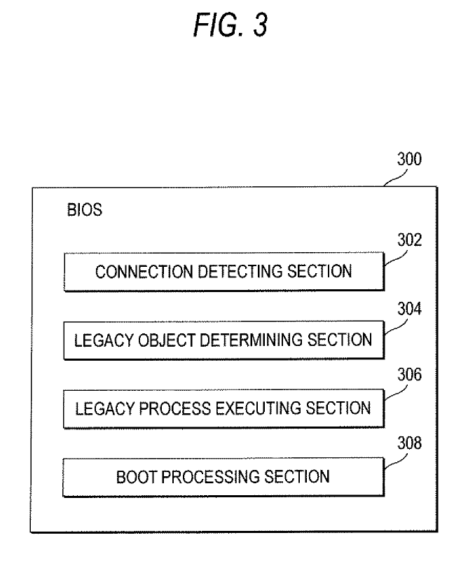

Now, referring to FIG. 3, a functional structure of the system BIOS 300 will be described.

The system BIOS 300 includes a connection detecting section 302, a legacy object determining section 304, a legacy process executing section 306 and a boot processing section 308 to control the USB device. The connection detecting section 302, the legacy object determining section 304, the legacy process executing section 306 and the boot processing section 308 are implemented as function modules in the system BIOS 300.

The connection detecting section 302 performs a process for discriminating whether or not the USB device is connected to the connection ports 31 to 34 for each of the connection ports 31 to 34. When the USB device is connected to any of the connection ports 31 to 34, the connection detecting section 302 determines a type of the USB device.

When the USB device is connected to any of the connection ports 31 to 34, the legacy object determining section 304 determines whether or not the USB device is a device as an object for a USB legacy process.

Here, the USB legacy process means a process for converting a signal from the USB controller 201 and the USB device into a signal of a form such as PS/2 or INT13h that can be controlled by the system BIOS 300 to assist the system BIOS 300 which does not have a function for controlling directly the USB controller 201 and the USB device. The USB legacy process enables the BIOS 300 to treat the USB controller 201 and the USE device as usual devices. In a below-described explanation, the process for converting the signal from the USB controller 201 and the USB device into the signal of the form of the PS/2 or the INT13h is referred to as a legacy emulation process.

As described above, the legacy object determining section 304 determines whether or not the USB device connected to the connection ports 31 to 34 is the USB device as an object for the USB legacy process such as the USB keyboard, the USB mouse, the USB memory or the like. The legacy object determining section 304 determines whether or not the USB device connected to the connection ports 31 to 34 is the USB device of a kind that can store the operating system, in other words, whether or not the USB device connected to the connection ports 31 to 34 is the USB storage decide such as the USB memory.

When the USB device as the object for the USB legacy process is connected to the connection port, the legacy process executing section 306 performs the USB legacy process. The USB legacy process is performed so that the legacy emulation process is performed. Thus, the system BIOS 300 is brought into a state that the system BIOS 300 can control the USB device such as the USB keyboard, the USB mouse, the USB memory or the like. Accordingly, in the computer 10 that executes the system BIOS 300, the USB device such as the USB keyboard, the USB mouse, the USB memory, etc. can be employed.

On the other hand, when the USB device as the object for the USE legacy process is not connected to the connection port, the legacy process executing section 306 terminates the USB legacy process. In this case, since the legacy emulation process is not performed, the system BIOS 300 is brought into a state that the system BIOS 300 cannot control the USB device such as the USB keyboard, the USB mouse, the USB memory or the like. Accordingly, in the computer 10 that executes the system BIOS 300, the USB device such as the USB keyboard, the USB mouse, the USB memory, etc. cannot be used.

The boot processing section 308 reads the operating system from a boot device to perform a process for booting up the computer 10. When the hard disk 117 is set as the boot device, the boot processing section 308 reads the operating system from the hard disk 117 to the main memory 113 to boot the operating system. On the other hand, when the USB memory 100 is set as the boot device, the boot processing section 308 treads the operating system from the USB memory 100 to the main memory 113 to boot the operating system.

The operating system of a new type such as Windows VISTA® may be read from the hard disk 117 to the main memory 113 and booted or may be read from the USB memory 100 to the main memory 113 and booted. On the other hand, it is not assumed that the operating system of an old type is read from the USB memory 100 to the main memory 113 and booted. In most of cases, the operating system is read from the hard disk 117 to the main memory 113 and booted.

When the operating system is the new type such as the Windows VISTA®, the operating system has a function for taking over the control of the USB device from the system BIOS 300. Accordingly, the operating system can smoothly take over the control of the USB device from the system BIOS 300 after the operating system is read from the hard disk 117 or the USB memory 100 and booted. Therefore, the operating system can normally use the USB device after the operating system is booted.

On the other hand, when the operating system is of an old type, the operating system does not have a function for taking over the control of the USB device from the system BIOS 300. However, in the embodiment, when the operating system of the old type is read from the hard disk 117 and booted, since the legacy process is forcedly terminated by the legacy process executing section 306, the operating system of the old type can control the USB controller 201 and the USB device after the USB controller 201 and the USB device are initialized. Thus, the operating system can normally use the USB device after the operating system is booted.

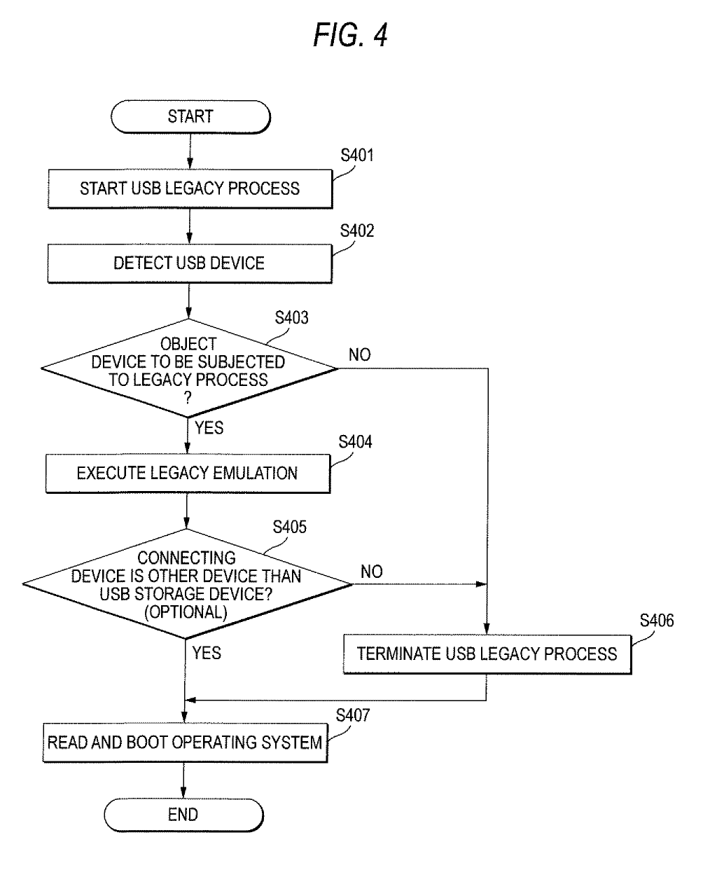

Now, referring to FIG. 4, the USB legacy process of the system BIOS during activating the personal computer 10 will be described below.

In step 401, the system BIOS starts the USB legacy process. Here, the system BIOS initializes the USB controller 201 for a BIOS control. In this initializing process, the system BIOS sets a BIOS control flag to “1” in a register incorporated in the USB controller 201 and sets an OS control flag “0”. As a result, the system BIOS is brought into a state that the system BIOS can control the USB device.

When the BIOS control flag is set to “0,” it is determined that the system BIOS does not control the USB device. When the BIOS control flag is set to “1,” it is determined that the system BIOS controls the USB device. When the OS control flag is set to “0” it is determined that the operating system does not control the USB device. When the OS control flag is set to “1,” it is determined that the operating system controls the USB device.

In step 402, the system BIOS determines whether or not the USB device is connected to the connection ports 31 to 34 of the personal computer 10. When the USB device is connected to the connection ports 31 to 34, the system BIOS determines a type of the USB device.

In step 403, the system BIOS determines whether or not the USB device connected to the connection ports 31 to 34 is a USB device as an object to be subjected to the USE legacy process such as the USB keyboard, the USB mouse, the USB memory, etc. Here, when it is determined that the USB device as the object to be subjected to the USB legacy process is connected to the connection ports 31 to 34, the process of the system BIOS proceeds to step 404. On the other hand, when it is determined that the USB device as the object to be subjected to the USB legacy process is not connected to the connection ports 31 to 34, the process of the system BIOS proceeds to step 406.

In step 404, the system BIOS performs the legacy emulation process. For example, the system BIOS converts the signal outputted from the USB keyboard or the USB mouse to make the USB keyboard or the USB mouse connected to the connection ports 31 to 34 look like a PS/2 keyboard or a PS/2 mouse. Further, the system BIOS converts the signal outputted from the USB memory to make the USB memory connected to the connection ports 31 to 34 look like the storage device for controlling the INT13h. As a result, in the computer 10, the USB device can be used.

The process of the system BIOS proceeds to step 405 from step 404. Since the process of step 405 is not essentially necessary, the process of the system BIOS may sometimes proceeds to step 407 from step 404.

When the process of the system BIOS proceeds to step 405 from step 404, in step 405, the system BIOS determines whether or not the USB device connected to the connection ports 31 to 34 is a USB device of a kind that can store the operating system. In other words, the system BIOS determines whether or not the USB device connected to the connection ports 31 to 34 is the USB storage device such as the USB memory.

When the USB device connected to the connection ports 31 to 34 includes the USB storage device such as the USB memory, the process of the system BIOS proceeds to step 407. On the other hand, when the USB device connected to the connection ports 31 to 34 includes only the USB keyboard or the USB mouse and does not include the USB storage device such as the USB memory, the process of the system BIOS proceeds to step 406.

When the process of the system BIOS proceeds to step 406 from step 403, in step 406, the system BIOS terminates the USB legacy process. As a result, the BIOS control flag of the register of the USB controller 201 is changed to “0” from “l”. Here, even when the USB legacy process is terminated, since it is recognized that the USB device as the object to be subjected to the USB legacy process is not connected to the connection ports, a problem does not arise that the USB device cannot be controlled. After that, the process of the system BIOS proceeds to step 407.

When the process of the system BIOS proceeds to step 406 from step 405, in step 406, the system BIOS terminates the USB legacy process. Consequently, the BIOS control flag of the register of the USB controller 201 is changed to “0” from “1”. Here, even when the USB legacy process is terminated, since it is recognized that the USB storage device is not connected to the connection ports, the USB storage device is not the boot device. Accordingly, a problem does not arise that the operating system cannot be read from the USB storage device. After that, the process of the system BIOS proceeds to step 407.

When the process of the system BIOS proceeds to step 407 from steps 404 and 405 or step 406, the system BIOS reads, in step 407, the operating system to the main memory 113 from the boot device and allows the CPU 111 to boot the operating system read to the main memory 113.

When the operating system of the new type such as the Windows VISTA® is booted, the operating system of the new type changes the OS control flag of the register of the USB controller 201 to “1” from “0”. At the same time, the operating system of the new type requests the system BIOS to take over the control of the USB device to allow the system BIOS to change the BIOS control flag to “0” from “1”. In accordance with a series of processes, the control of the USB device can be smoothly taken over to the USB driver of the operating system from the system BIOS.

On the other hand, when a conventional operating system of an old type is booted, since the legacy process is terminated in step 406, the control of the USB controller 201 and the USB device by the system BIOS is terminated. Accordingly, the operating system of the old type initializes the USE controller 201 and the USB device, and then, controls the USB device. In accordance with the above-described series of processes, the control of the USB device can be smoothly taken over to the USB driver of the operating system from the system BIOS.

According to the computer 10 of the embodiment, in both cases when the operating system of the new type such as the Windows VISTA® is booted and when the conventional operating system of the old type is booted, a situation can be prevented from arising that the USB device cannot be controlled.

In the computer 10 of the embodiment, since the legacy process is continuously performed so that the USB keyboard can be used before the operating system is read by the above-described process of step 405, a user can use the USB keyboard or the USB mouse during the operation of the system BIOS, for example, the user can execute various settings of the system BIOS.

It is to be understood that the present invention is not limited to the specific embodiment described above and that the invention can be embodied with the components modified without departing from the spirit and scope of the invention. The invention can be embodied in various forms according to appropriate combinations of the components disclosed in the embodiments described above. For example, some components may be deleted from all components shown in the embodiment.

What is claimed is:

1. An information processing apparatus comprising:
a connection port to which an external device is connected; and
a processor that executes a BIOS and runs an operating system,
wherein, when executing the BIOS, the processor operates to:
determine whether or not the external device is connected to the connection port;
continues to perform a legacy process and boot the operating system when determined that a prescribed type of the external device is connected; and
terminates the legacy process and boot the operating system when determined that the prescribed type of the external device is not connected.

2. The apparatus according to claim 1, wherein the processor operates to:
continue to perform the legacy process and boot the operating system when determined that the connected external device is of a type that is to be subjected to the legacy process; and
terminates the legacy process and boot the operating system when determined that the external device of the type that is to be subjected to the legacy process is not connected.

3. The apparatus according to claim 2 further comprises an internal storage device that stores a first operating system,
wherein the processor operates to:
continue to perform the legacy process and boot a second operating system stored in an external storage device when the external storage device is connected to the connection port; and
terminates the legacy process and boot the first operating system stored in the internal storage device when determined that the external device connected to the connection port is not the external storage device that stores the second operating system.

4. The apparatus according to claim 2 further comprises an internal storage device that stores the operating system,
wherein, when determined that the external device connected to the connection port is not an external storage device, the processor operates to:
continue to perform the legacy process until starting to read the operating system from the internal storage device and enable access to the external device;
terminate the legacy process when reading the operating system from the internal storage device; and
boot the operating system when the legacy process is terminated.

5. The apparatus according to claim 1, wherein the operating system is one of a first operating system having a function for taking over control of the external device from the BIOS and a second operating system having no function for taking over control of the external device from the BIOS.

6. The apparatus according to claim 6, wherein the function for taking over control of the external device from the BIOS is a function for rewriting a BIOS control flag indicating that the external device is under the control of the BIOS and an OS control flag indicating that the external device is under the control of the operating system.

7. The apparatus according to claim 1, wherein the connection port and the external device are compatible with a universal serial bus standard.
